(19) United States
(12) Patent Application Publication
(10) Pub. No.: US 2025/0231019 A1
(43) Pub. Date: Jul. 17, 2025

(54) METHOD FOR DETERMINING A HEIGHT MAP USING A WHITE LIGHT INTERFEROMETER AND WHITE LIGHT INTERFEROMETER FOR THE SAME

(71) Applicant: MITUTOYO CORPORATION, Kanagawa (JP)

(72) Inventors: Nitish KUMAR, Veldhoven (NL); Neeraj KUMAR, Eindhoven (NL)

(73) Assignee: MITUTOYO CORPORATION, Kanagawa (JP)

(21) Appl. No.: 19/012,029

(22) Filed: Jan. 7, 2025

(30) Foreign Application Priority Data
Jan. 11, 2024 (EP) 24151279.7

(51) Int. Cl. G01B 11/06; G01B 11/30

(52) U.S. Cl. CPC G01B 11/0608; G01B 11/303

(57) ABSTRACT

The invention relates to a method for determining a height map of a surface of a sample through white light interferometry wherein use is made of a white light interferometer with a broad band light source and an optical sensor including pixels. The invention further relates to a white light interferometer including a broad band light source, an optical sensor including pixels and a processor configured for performing the method of the invention. The invention further relates to a digital data carrier including a computer program which, when run on a processor of a white light interferometer according to the invention, causes the white light interferometer to perform the method according to the invention.

### FIELD OF THE INVENTION

The invention relates to a method for determining a height map of a surface of a sample through white light interferometry wherein use is made of a white light interferometer including a broad band light source and an optical sensor with multiple pixels. The invention further relates to a white light interferometer including a broad band light source, an optical sensor with multiple pixels and a processor configured for performing the method of the invention.

The invention further relates to a digital data carrier including a computer program which, when run on a processor of a white light interferometer according to the invention, causes the white light interferometer to perform the method according to the invention.

### BACKGROUND OF THE INVENTION

White light interferometry is a standard technique for determining a height map of a surface of a sample. White light interferometry may allow for very hight accuracies of approximately 1 nm. An example of a method of white light interferometry for determining a height map may be found in EP2314982 B1, wherein a zero phase crossing method is used.

With increasing requirements in measurement precision, for example in the measuring of height maps, a need arises to increase the accuracy of white light interferometry, e.g. when used in determining height maps. A downside in using white light interferometry for determining a height map of a sample is that vibrations of the sample relative to the white light interferometer may cause inaccuracies in the determined height map. White light interferometry relies on determining phase differences of reflected light due to differences in path length of light traveling along light paths in the interferometer. The path lengths may be influenced by vibrations of the sample, which in turn effects the phase differences and thus results in inaccurate height maps.

Vibrations of the sample relative to the white light interferometer may arise due to instabilities of a sample holder. The sample holder may be influenced by various kinds of vibrations from surroundings of the white light interferometer, such as arising from vehicles or people moving. The sample holder may also be influenced by vibrations which may arise from the presence of other instruments, such as typically present in a laboratory or manufacturing environment.

If a sufficient care to eliminate the effect of vibrations on the sample is not taken, an accuracy of a determined height map may be negatively impacted. In some cases, a determined height map may be useless due to the too large errors therein. Vibrations may effect overall accuracy, reliability and repeatability of the results of the white light interferometer.

Known methods of reducing the effect of vibrations on the result of white light interferometry include the use of vibration dampers to isolate the white light interferometer from vibrational effects of the environment. A downside of these known methods is an increase in overall costs. Additionally, the dampers may not sufficiently reduce the effect of the vibrations depending on the type of dampers and type of vibrations.

### OBJECT OF THE INVENTION

There exists a need for a method for determining a height map of a sample surface of a sample with a reduced dependency on vibrations.

One aim of the invention is to provide an improved method for determining a height map of a sample surface of a sample with a reduced dependency of vibrations thereon compared to known methods. It is a further aim of the invention to provide an alternative method for determining a height map of a sample surface of a sample with a reduced dependency of vibrations thereon compared to known methods.

### SUMMARY OF THE INVENTION

One aim of the invention is achieved by the method according to the present disclosure.

The invention relies on the insight that the use of an algorithm based on a principal component analysis of a stack of interferograms allows for a method of determining a height map that reduces the dependency on random phase shifts in the interferograms used, e.g. such as random phase shifts resulting from vibrations. A method based on the principal component analysis allows to separate the random phase shifts from phase shifts related to the height of the sample. The phase shifts related to the height of the sample are denoted measured phase in this document. As a result, the invention allows for an improved or alternative method of determining a height map compared to known methods for determining a height map using known methods to reduce the effect of vibrations.

The invention relates to a method for determining a height map of a sample surface of a sample through white light interferometry. A height map of a sample surface may be determined to determine a roughness of the sample surface. A height map of a sample surface may further be determined to provide a quality control, e.g. of a production process.

White light interferometry is a non-contact optical method for surface height measurements on surfaces with surface profiles.

The method makes use of a white light interferometer including a broad band light source and an optical sensor with multiple pixels. The white light interferometer may further include a processor for causing the white light interferometer to determine the height map according to a method, e.g. according to the method of the invention. The light source may emit light to a beam splitter which splits the light into a reference light beam and a measurement light beam. The reference light beam may follow a first path towards the optical sensor and the measurement light beam may follow a second path, reflecting on the sample surface, to the optical sensor. Both light beams interfere with each other which results in an interference pattern and allows the interferometer to measure an interferogram associated with the sample surface at a specific position thereof relative to the interferometer. Height differences of the sample surface result in slightly different travel distances for different parts of the measurement light beam, which translate into fringes in the interferogram via resulting relative phase differences. This allows to extract the height of the sample surface by associating the height of the sample surface to the resulting relative phase difference. The interferometer may further include a sample holder or sample stage, e.g. which is movable in a direction parallel to the measurement light beam to allow for different measurements position relative to a focal plane of the optical sensor.

The method includes obtaining a stack of interferograms by vertical scanning of the sample surface through a focal plane of the optical sensor, wherein each interferogram includes a measured light intensity for each pixel of the optical sensor at a respective height relative to the surface. Thus, each interferogram of the stack is associated with a height of the sample surface relative to the optical sensor and/or the optical plane. To obtain the stack, the sample surface is moved vertically, e.g. by vertical scanning, wherein the vertical direction is understood to be a direction parallel to the measurement light beam at the sample surface. The sample surface may be moved between different measurement positions and at each measurement position an interferogram is determined. The interferogram may be represented by an M×N matrix, e.g. when the optical sensor has M×N pixels, wherein each entry of the M×N matrix includes an intensity of the associated pixel. The intensity contains information related to the relative phase of the measured light at that pixel for the associated interferogram. Thus by obtaining a stack of Z interferograms, a total of Z M×N matrices may be obtained. For example, the Z M×N matrices may be represented by a single three-dimensional M×N×Z matrix. The three-dimensional M×N×Z matrix representing the stack of interferograms may be reshaped to a two-dimensional M*N×Z matrix A_{M*N×2}, wherein each column is associated to an interferogram of the stack of interferograms. It may be shown that the two-dimensional M*N×Z matrix A_{M*N×z} may be written as a sum:

$${A}_{M * N \times Z} = {a}_{Z} {u}_{M * N} + {b}_{Z} {v}_{M * N}$$

wherein u_{M*N}=B cos(φ_{M*N}) and v_{M*N}=B sin (φ_{M*N}), where φ_{M*N} is the measured phase which is be related to the height of the surface at a pixel, B is the modulation amplitude and a_{Z} and b_{Z} depend on the random phases shifts and not on φ_{M*N}.

It may be shown that the two signals u_{M*N} and v_{M*N} are approximately uncorrelated such that A_{M*N×Z} may be decomposed into u_{M*N} and v_{M*N}, thus removing the dependency on the random phase shifts associated to random vibrations of the sample relative to the interferometer.

The signals u_{M*N} and v_{M*N} may be obtained by performing a principal component analysis on the stack of interferograms, e.g. on the matrix representing the stack of interferograms A_{M*N×Z}. To this end, the method further includes determining a covariance matrix for the stack of interferograms. A covariance matrix may be a square and symmetric matrix which may be obtained by multiplying a matrix with its own transpose. The reshaped two-dimensional matrix A_{M*N×Z} may be multiplied with its transpose such that a M*N×M*N covariance matrix of the stack of interferograms is obtained.

In order to determine the principal components of the stack of interferograms, a singular value decomposition is performed on the associated covariance matrix. The singular value decomposition allows to decompose the square matrix into an orthogonal matrix and a diagonal matrix. The principal components of the covariance matrix may then be obtained by calculating a projection of the matrix A_{M*N×Z} on the orthogonal matrix of the singular value decomposition, e.g.

$$Y = Φ {A}_{M * N \times Z} .$$

Here Y includes the principal components of A_{M*N×Z}, i.e. of the stack of interferograms, and Φ is the orthogonal matrix of the singular value decomposition.

It may be shown that the principal component associated with the largest eigenvalue and the principal component associated with the second largest eigenvalue correspond to the signals u_{M*N} and v_{M*N} (which are vectors with each entry thereof associated with a pixel of the optical sensor and which are proportional to the sine and cosine of the measured phase). Thus, by taking ratios of the components of u_{M*N} and v_{M*N}, ratios of sines and cosines may be obtained. As a result, for example taking a tangent of such a ratio may result in obtaining of the measured phase at a respective pixel may.

The method therefore includes, selecting a first principal component associated with a biggest eigenvalue of the covariance matrix and a second principal component associated with a second biggest eigenvalue of the covariance matrix and taking the ratio of ratio of vector components of the first and second principal components. The measured phase may be determined based on this ratio. The height map is obtained based on the measured phase for each pixel, e.g. based on an average wavelength of the broad band light source.

The invention is further based on the insight that the obtained measured phases for the pixels have an undetermined global sign. This global sign is a result of the singular value decomposition of the covariance matrix and the use of the orthogonal matrix Φ in determining the principal components. As may be appreciated, the orthogonal matrix Φ appears twice in the singular value decomposition of the covariance matrix and is thus not uniquely determined due to a possible global sign change thereof. As a result, the determined principal components are also not unique determined up to a sign, which results in the unknown global sign of the measured phase. The inventors realised that the correct global sign may be determined by looking at phases of the first and second principal components. The first and second principal components viewed as vectors, always have a phase difference of ±π/2 with the correct global sign for the height map when the first principal component lagging behind the second principal component by π/2. If this is not the case, the global sign has to be reversed, relative to the sign used when determining the Hilbert transformed eigenvectors, to obtain the correct height map.

In order to determine if the global sign of the measured phase is correct the method further includes performing a Hilbert transform on an eigenvector of the covariance matrix that is associated with the biggest eigenvalue thereof, obtaining a complex Hilbert transformed eigenvector. The real part of the Hilbert transformed eigenvector lags behind the imaginary part of the Hilbert transported eigenvector precisely by a factor π/2.

Thus, by determining a reference phase for a reference pixel of the pixels based on, e.g. by taking by taking an arctangent of, a ratio of vector components of the real part and imaginary part of the Hilbert transformed eigenvector, wherein the respective vector components are associated with the reference pixel and determining if the measured phase of the reference pixel corresponds to the reference phase of the reference pixel, it may be checked if the global sign of the measured phase is correct by checking if the measured phase of the reference pixel corresponds to the reference phase and reversing the global sign of the height map, e.g. of the measured phases, if the measured phase does not correspond to the reference phase. Thus, this allows to determine a height map of the sample surface with a correct global sign.

In embodiments, the determining if the measured phase of the reference pixel corresponds to the reference phase of the reference pixel includes:
calculating a magnitude of a sum of the measured phase and the reference phase of the reference pixel and calculating a magnitude of a difference between the measured phase and the reference phase of the reference pixel; and
determining that the measured phase of the reference pixel corresponds to the reference phase if the magnitude of the difference is smaller than the magnitude of the sum and determining that the measured phase of the reference pixel does not correspond to the reference phase if the magnitude of the difference is larger than the magnitude of the sum.

This provides explicit steps to determine whether or not the measured phase of the reference pixel corresponds to the reference phase of the reference pixel.

An aim of the invention is also achieved by a second method of the disclosure, which obtains the measured phases in the same way as the above-described method, but differs in determining the correct global sign. The second method includes:
taking a Fourier transform of a first eigenvector of the covariance matrix which is associated with the biggest eigenvalue and taking a Fourier transform of a second eigenvector of the covariance matrix which is associated with the second biggest eigenvalue;
determining a highest magnitude frequency of the Fourier transformed first eigenvector;
calculating a first Fourier phase of the Fourier transformed first eigenvector and a second Fourier phase of the Fourier transformed second eigenvector associated with the determined highest magnitude frequency;
determining a difference between the first Fourier phase and the second Fourier phase by subtracting the second Fourier phase from the first Fourier phase; and
if the difference between the First Fourier phase and the second Fourier phase is between 0 and π modulo 2π, reversing a global sign of the determined height map.

Thus, accordingly the phase difference between the first and second principal components is checked by looking at a phase difference of the associated Fourier transformed vectors. The global sign of the height map is revered, relative to the sign used to check the difference between the Fourier phases, if the difference therebetween is between 0 and π modulo 2π.

In embodiments, the ratio of vector components of the first and second principal components is proportional to the vector component of the second principal component divided by the vector component of the first principal component. This may allow to use the arctangent to determine the measured phase.

In embodiments, determining the covariance matrix includes removing an average intensity of the stack of interferograms. The average intensity may be determined by determining a mean of the intensity of the stack of interferograms. The so determined average intensity may be removed from each entry of the matrix representation of the stack of interferograms.

In embodiments, determining the covariance matrix includes reshaping a three-dimensional M×N×Z matrix representative of the stack of interferograms to a two-dimensional M*N×Z matrix, wherein the optical sensor has M×N pixels and the stack includes Z interferograms.

In embodiments determining the height map based on the determined measured phase for each pixel includes multiplying the determined measured phase with a central wavelength of the broad band light source.

The invention further relates to a white light interferometer including a broad band light source, an optical sensor including pixels and a processor for obtaining a height map of a surface of a sample, wherein the white light interferometer, e.g. the processor thereof, is configured for performing the method according to the invention.

In embodiments, the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,

and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, by taking an arctangent of a ratio of vector components of the first and second principal components, wherein the vector components are associated with the respective pixel; and
determining the height map based on the determined measured phase for each pixel,

wherein the processor is further configured for:
performing a Hilbert transform on an eigenvector of the covariance matrix associated with the biggest eigenvalue thereof obtaining a complex Hilbert transformed eigenvector;
determining a reference phase for a reference pixel of the pixels by taking an arctangent of a ratio of vector components of the real part and imaginary part of the Hilbert transformed eigenvector, wherein the vector components are associated with the reference pixel;
determining if the measured phase of the reference pixel corresponds to the reference phase; and
if the measured phase of the reference pixel does not correspond to the reference phase, reversing a global sign of the determined height map.

In embodiments of the white light interferometer, the processor is configured for:
calculating a magnitude of a sum of the measured phase of the reference pixel and the reference phase and calculating a magnitude of a difference between the measured phase of the reference pixel and the reference phase; and
determining that the measured phase of the reference pixel corresponds to the reference phase if the magnitude of the difference is smaller than the magnitude of the sum and determining that the measured phase of the reference pixel does not correspond to the reference phase if the magnitude of the difference is larger than the magnitude of the sum.

In embodiments, the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,

and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, by taking an arctangent of a ratio of vector components of the first and second principal components, wherein the vector components are associated with the respective pixel; and
determining the height map based on the determined measured phase for each pixel,

wherein the processor is further configured for:
taking a Fourier transform of a first eigenvector of the covariance matrix which is associated with the biggest eigenvalue and taking a Fourier transform of a second eigenvector of the covariance matrix which is associated with the second biggest eigenvalue;
determining a highest magnitude frequency of the Fourier transformed first eigenvector;
calculating a first Fourier phase of the Fourier transformed first eigenvector and a second Fourier phase of the Fourier transformed second eigenvector associated with the determined highest magnitude frequency;
determining a difference between the first Fourier phase and the second Fourier phase by subtracting the second Fourier phase from the first Fourier phase; and
if the difference between the First Fourier phase and the second Fourier phase is between 0 and π modulo 2π, reversing a global sign of the determined height map.

The invention further relates to a digital data carrier including a computer program which, when run on a processor of a white light interferometer according to the invention, causes the white light interferometer to perform the method according to the invention.

### BRIEF DESCRIPTION OF THE DRAWINGS

Embodiments of the invention will now be described, by way of example, with reference to the accompanying drawing in which corresponding reference symbols indicate corresponding parts, and in which:

FIG. 1 depicts a white light interferometer for determining a height map; and

FIG. 2 depicts a flow chart of a method for determining a height map.

### DESCRIPTION OF THE EMBODIMENTS

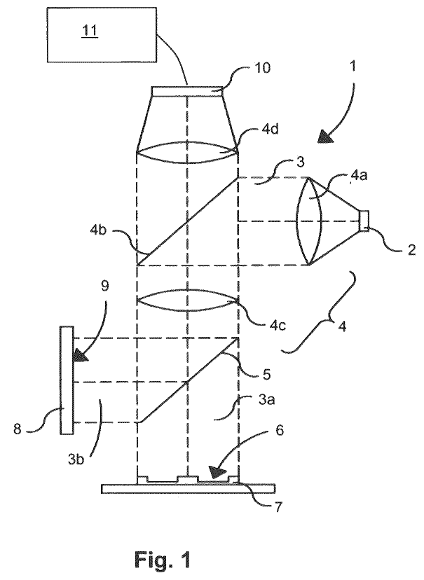

FIG. 1 depicts an example of a white light interferometer 1 for determining a height map. The interferometer includes a broadband light source 2. Light 3 from the light source 2 may pass through a lens 4a, a beamsplitter 4b, and a second lens 4c. After passing through the second lens 4c, the light 3 is split by a beamsplitter 5 into a first partial light beam 4a and a second partial light beam 3b. The first partial light beam 3a is directed to a surface 6 of a sample 7. The second partial light beam 3b is directed to a reference mirror 8 with a reference surface 9. After reflection by the mirrors 6 an d8, the partial light beams 3a, 3b are combined and propagate to the optical sensor 10 with multiple pixels. For example, the optical sensor 10 may be an CCD array camera 10. This setup results in an interference signal on the optical sensor 10.

The pixels of the optical sensor 10 may correspond to a spatial position on the sample surface 6 and on the reference surface 9. After vertical scanning, each pixel may have an associated intensity signal which maybe associated to a height at a corresponding spatial position of the sample 7.

The sample 7 may be moved through an focal plane of the second lens 4c and for multiple positions of the sample 7 relative to the interferometer 1 an interferogram is captured by the optical sensor 10. In this way, a stack of interferograms may be obtained 101 by the interferometer 1, which stack of interferograms may be received by the processor 11 to allow the processor to determine the height map based on the method of the invention.

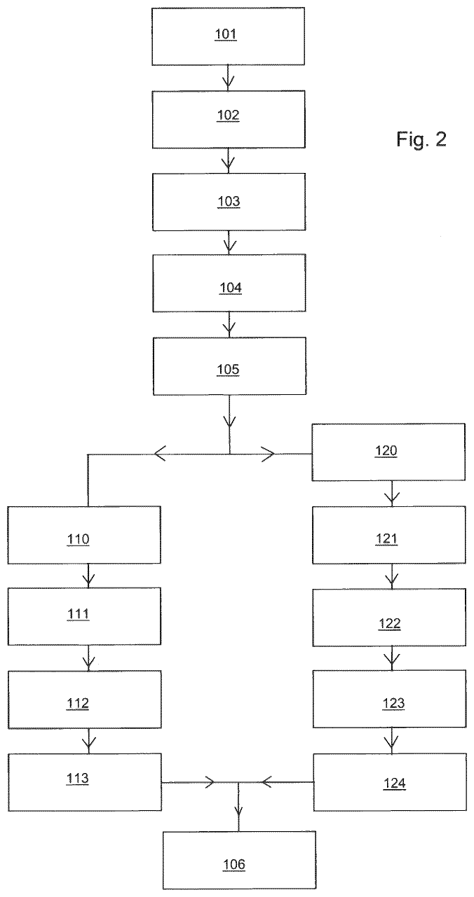

FIG. 2 depicts a flow chart of a method for determining a height map, wherein the method includes:
obtaining 101 a stack of interferograms by vertical scanning of the surface 6 through a focal plane of the optical sensor 10, wherein each interferogram includes a measured light intensity for each pixel of the optical sensor 10 at a respective height of the surface 6 relative to the focal plane;
determining 102 a covariance matrix for the stack of interferograms;
determining 103 principal components of the stack of interferograms by performing a singular value decomposition of the covariance matrix;
selecting 104 a first principal component associated with a biggest eigenvalue of the covariance matrix and a second principal component associated with a second biggest eigenvalue of the covariance matrix; and
determining 105 a measured phase, for each pixel of the pixels, based on, e.g. by taking an arctangent of, a ratio of vector components of the first and second principal components, wherein the respective vector components are associated with the respective pixel.

As explained in the description above, and as may be seen in FIG. 2, the invention allows to determine the correct global sign in front of the measured phase based on two methods, both based on the insight that the correct sign is obtained when the first principal component lags behind the second principal component by π/2. The determining 106 the height map based on the measured phase for each pixel thus includes either:
performing 110 a Hilbert transform on an eigenvector of the covariance matrix associated with the biggest eigenvalue thereof obtaining a complex Hilbert transformed eigenvector;
determining 111 a reference phase for a reference pixel of the pixels based on, e.g. by taking by taking an arctangent of, a ratio of vector components of the real part and imaginary part of the Hilbert transformed eigenvector, wherein the respective vector components are associated with the reference pixel;
determining 112 if the measured phase of the reference pixel corresponds to the reference phase of the reference pixel; and
if the measured phase of the reference pixel does not correspond to the reference phase, reversing 113 a global sign of the measured phase, e.g. the height map.

Or the determining 106 the height map based on the measured phase for each pixel includes:
taking 120 a Fourier transform of a first eigenvector of the covariance matrix which is associated with the biggest eigenvalue and taking a Fourier transform of a second eigenvector of the covariance matrix which is associated with the second biggest eigenvalue;
determining 121 a highest magnitude frequency of the Fourier transformed first eigenvector;
calculating 122 a first Fourier phase of the Fourier transformed first eigenvector and a second Fourier phase of the Fourier transformed second eigenvector associated with the determined highest magnitude frequency;
determining 123 a difference between the first Fourier phase and the second Fourier phase by subtracting the second Fourier phase from the first Fourier phase; and
if the difference between the First Fourier phase and the second Fourier phase is between 0 and π modulo 2π, reversing 124 a global sign of the measured phase, e.g. the height map.

What is claimed is:

1. A method for determining a height map of a sample surface of a sample through white light interferometry wherein use is made of a white light interferometer including a broad band light source and an optical sensor with multiple pixels, wherein the method includes:
obtaining a stack of interferograms by vertical scanning of the surface through a focal plane of the optical sensor, wherein each interferogram includes a measured light intensity for each pixel of the optical sensor at a respective height of the surface relative to the focal plane;
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on, a ratio of vector components of the first and second principal components, wherein the respective vector components are associated with the respective pixel; and
determining the height map based on the measured phase for each pixel,
wherein the determining the height map includes:
performing a Hilbert transform on an eigenvector of the covariance matrix associated with the biggest eigenvalue thereof obtaining a complex Hilbert transformed eigenvector;
determining a reference phase for a reference pixel of the pixels based on a ratio of vector components of the real part and imaginary part of the Hilbert transformed eigenvector, wherein the respective vector components are associated with the reference pixel;
determining if the measured phase of the reference pixel corresponds to the reference phase of the reference pixel; and
if the measured phase of the reference pixel does not correspond to the reference phase, reversing a global sign of the measured phase.

2. The method according to claim 1, wherein the determining if the measured phase of the reference pixel corresponds to the reference phase of the reference pixel includes:
calculating a magnitude of a sum of the measured phase and the reference phase of the reference pixel and calculating a magnitude of a difference between the measured phase and the reference phase of the reference pixel; and
determining that the measured phase of the reference pixel corresponds to the reference phase if the magnitude of the difference is smaller than the magnitude of the sum and determining that the measured phase of the reference pixel does not correspond to the reference phase if the magnitude of the difference is larger than the magnitude of the sum.

3. A method for determining a height map of a surface of a sample through white light interferometry wherein use is made of a white light interferometer including a broad band light source and an optical sensor with multiple pixels, wherein the method includes:
obtaining a stack of interferograms by vertical scanning of the surface through a focal plane of the optical sensor, wherein each interferogram includes a measured light intensity for each pixel of the optical sensor at a respective height relative to the surface;
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on a ratio of vector components of the first and second principal components, wherein the respective vector components are associated with the respective pixel; and
determining the height map based on the determined measured phase for each pixel,
wherein the determining the height map includes:
taking a Fourier transform of a first eigenvector of the covariance matrix which is associated with the biggest eigenvalue and taking a Fourier transform of a second eigenvector of the covariance matrix which is associated with the second biggest eigenvalue;
determining a highest magnitude frequency of the Fourier transformed first eigenvector;
calculating a first Fourier phase of the Fourier transformed first eigenvector and a second Fourier phase of the Fourier transformed second eigenvector associated with the determined highest magnitude frequency;
determining a difference between the first Fourier phase and the second Fourier phase by subtracting the second Fourier phase from the first Fourier phase; and
if the difference between the First Fourier phase and the second Fourier phase is between 0 and π modulo 2π, reversing a global sign of the measured phase.

4. The method according to claim 1, wherein the ratio of vector components of the first and second principal components is proportional to vector component of the second principal component divided by the vector component of the first principal component.

5. The method according to claim 1, wherein determining the covariance matrix includes removing an average intensity of the stack of interferograms.

6. The method according to claim 1, wherein determining the covariance matrix includes reshaping a three-dimensional M×N×Z matrix representative of the stack of interferograms to a two-dimensional M*N×Z matrix, wherein the optical sensor has M×N pixels and the stack includes Z interferograms.

7. The method according to claim 1, wherein determining the height map based on the determined measured phase for each pixel includes multiplying the determined measured phase with a central wavelength of the broad band light source.

8. A white light interferometer including a broad band light source, an optical sensor including pixels and a processor for obtaining a height map of a surface of a sample, wherein the white light interferometer is configured for performing the method according to claim 1.

9. The white light interferometer according to claim 8, wherein the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,
and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on a ratio of vector components of the first and second principal components, wherein the vector components are associated with the respective pixel; and
determining the height map based on the determined measured phase for each pixel,
wherein the determining the height map includes:
performing a Hilbert transform on an eigenvector of the covariance matrix associated with the biggest eigenvalue thereof obtaining a complex Hilbert transformed eigenvector;
determining a reference phase for a reference pixel of the pixels based on a ratio of vector components of the real part and imaginary part of the Hilbert transformed eigenvector, wherein the vector components are associated with the reference pixel;
determining if the measured phase of the reference pixel corresponds to the reference phase; and
if the measured phase of the reference pixel does not correspond to the reference phase, reversing a global sign of the measured phase.

10. The white light interferometer according to claim 9, wherein the processor is configured for:
calculating a magnitude of a sum of the measured phase of the reference pixel and the reference phase and calculating a magnitude of a difference between the measured phase of the reference pixel and the reference phase; and
determining that the measured phase of the reference pixel corresponds to the reference phase if the magnitude of the difference is smaller than the magnitude of the sum and determining that the measured phase of the reference pixel does not correspond to the reference phase if the magnitude of the difference is larger than the magnitude of the sum.

11. The method according to claim 8, wherein the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,
and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on a ratio of vector components of the first and second principal components, wherein the vector components are associated with the respective pixel; and
determining the height map based on the determined measured phase for each pixel,
wherein the determining the height map includes:
taking a Fourier transform of a first eigenvector of the covariance matrix which is associated with the biggest eigenvalue and taking a Fourier transform of a second eigenvector of the covariance matrix which is associated with the second biggest eigenvalue;
determining a highest magnitude frequency of the Fourier transformed first eigenvector;
calculating a first Fourier phase of the Fourier transformed first eigenvector and a second Fourier phase of the Fourier transformed second eigenvector associated with the determined highest magnitude frequency;
determining a difference between the first Fourier phase and the second Fourier phase by subtracting the second Fourier phase from the first Fourier phase; and
if the difference between the First Fourier phase and the second Fourier phase is between 0 and π modulo 2π, reversing a global sign of the measured phase.

12. A digital data carrier including a computer program which, when run on a processor of a white light interferometer including a broad band light source, an optical sensor including pixels and a processor for obtaining a height map of a surface of a sample, causes the white light interferometer to perform the method according to claim 1.

13. The method according to claim 3, wherein the ratio of vector components of the first and second principal components is proportional to vector component of the second principal component divided by the vector component of the first principal component.

14. The method according to claim 3, wherein determining the covariance matrix includes removing an average intensity of the stack of interferograms.

15. The method according to claim 3, wherein determining the covariance matrix includes reshaping a three-dimensional M×N×Z matrix representative of the stack of interferograms to a two-dimensional M*N×Z matrix, wherein the optical sensor has M×N pixels and the stack includes Z interferograms.

16. The method according to claim 3, wherein determining the height map based on the determined measured phase for each pixel includes multiplying the determined measured phase with a central wavelength of the broad band light source.

17. A white light interferometer including a broad band light source, an optical sensor including pixels and a processor for obtaining a height map of a surface of a sample, wherein the white light interferometer is configured for performing the method according to claim 3.

18. The white light interferometer according to claim 17, wherein the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,
and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on a ratio of vector components of the first and second principal components, wherein the vector components are associated with the respective pixel; and
determining the height map based on the determined measured phase for each pixel,
wherein the determining the height map includes:
performing a Hilbert transform on an eigenvector of the covariance matrix associated with the biggest eigenvalue thereof obtaining a complex Hilbert transformed eigenvector;
determining a reference phase for a reference pixel of the pixels based on a ratio of vector components of the real part and imaginary part of the Hilbert transformed eigenvector, wherein the vector components are associated with the reference pixel;
determining if the measured phase of the reference pixel corresponds to the reference phase; and
if the measured phase of the reference pixel does not correspond to the reference phase, reversing a global sign of the measured phase.

19. The white light interferometer according to claim 18, wherein the processor is configured for:
calculating a magnitude of a sum of the measured phase of the reference pixel and the reference phase and calculating a magnitude of a difference between the measured phase of the reference pixel and the reference phase; and
determining that the measured phase of the reference pixel corresponds to the reference phase if the magnitude of the difference is smaller than the magnitude of the sum and determining that the measured phase of the reference pixel does not correspond to the reference phase if the magnitude of the difference is larger than the magnitude of the sum.

20. The method according to claim 17, wherein the white light interferometer is configured for:
obtaining a stack of interferograms by vertical scanning of the surface through a focal plane of the optical sensor, wherein each interferogram includes a measured light intensity for each pixel of the optical sensor at a respective height relative to the surface,
and wherein the processer is configured for:
determining a covariance matrix for the stack of interferograms;
determining principal components of the stack of interferograms by performing a singular value decomposition of the covariance matrix;
selecting a first principal component associated with a biggest eigenvalue of the covariance matrix and a second principal component associated with a second biggest eigenvalue of the covariance matrix;
determining a measured phase, for each pixel of the pixels, based on a ratio of vector components of the first and second principal components, wherein the vector components are associated with the respective pixel; and
determining the height map based on the determined measured phase for each pixel,
wherein the determining the height map includes:
taking a Fourier transform of a first eigenvector of the covariance matrix which is associated with the biggest eigenvalue and taking a Fourier transform of a second eigenvector of the covariance matrix which is associated with the second biggest eigenvalue;
determining a highest magnitude frequency of the Fourier transformed first eigenvector;
calculating a first Fourier phase of the Fourier transformed first eigenvector and a second Fourier phase of the Fourier transformed second eigenvector associated with the determined highest magnitude frequency;
determining a difference between the first Fourier phase and the second Fourier phase by subtracting the second Fourier phase from the first Fourier phase; and
if the difference between the First Fourier phase and the second Fourier phase is between 0 and π modulo 2π, reversing a global sign of the measured phase.

21. A digital data carrier including a computer program which, when run on a processor of a white light interferometer including a broad band light source, an optical sensor including pixels and a processor for obtaining a height map of a surface of a sample, causes the white light interferometer to perform the method according to claim 3.
